(19) United States
(12) Patent Application Publication
(10) Pub. No.: US 2025/0077306 A1
(43) Pub. Date: Mar. 6, 2025

(54) WORKLOAD MANAGEMENT FOR SUSTAINABLE COMPUTING ON UNSTABLE POWER ENVIRONMENT

(71) Applicant: INTERNATIONAL BUSINESS MACHINES CORPORATION, ARMONK, NY (US)

(72) Inventors: Guang Han Sui, Beijing (CN); Peng Hui Jiang, Beijing (CN); Fan Jing Meng, Beijing (CN); Ming Liang Zu, Beijing (CN); Jun Su, Beijing (CN)

(21) Appl. No.: 18/459,016

(22) Filed: Aug. 30, 2023

(51) Int. Cl. G06F 9/50

(52) U.S. Cl. CPC G06F 9/5094

(57) ABSTRACT

A computer-implemented method for computing workload management includes collecting power usage information from a location and collecting computing task information with respect to computing tasks performed at the location. The collected computing task information can be parsed to get a predicted approximate power usage information for each task. The tasks can be scheduled based on the predicted approximate power usage information to improve (e.g., maximize) usage of power from an unstable power source.

### BACKGROUND

The present disclosure generally relates to systems and methods for managing workload, and more particularly, to a computer-implemented method, a computer system, and a computer program product that provide workload management solutions using sustainable power sources.

Sustainable computing is about how to manage computing devices to reduce their environmental impact thus making them environmentally sustainable. Sustainable power is salient for sustainable computing, while some sustainable power (e.g., wind power, optical energy) is not stable over time.

### SUMMARY

In one embodiment, a system and method are provided that can provide a solution to get power usage of tasks and schedule these tasks to make full use of the unstable power. Such systems and methods can make full use of unstable power while removing the need for costly energy storage. Further, in such systems and methods, all the needed information is from the existing environment and it can be applied to production environment without a need to change the workload pattern to collect information. Thus, the impact to the system is low, without a need to be inserted into a Linux kernel and without impact on the system performance.

In one embodiment, a computer implemented method and a computer program product can be configured to collect power usage information from a location and collect computing task information with respect to computing tasks performed at the location. The collected computing task information can be parsed to get a predicted approximate power usage information for each task. Tasks can be scheduled based on the predicted approximate power usage information to improve (e.g., maximize) usage of power from an unstable power source.

In another embodiment, a system includes a processor, a data bus coupled to the processor, a memory coupled to the data bus, and a computer-usable medium embodying a computer program code. The computer program code includes instructions executable by the processor and configured to collect power usage information from a location and collect computing task information with respect to computing tasks performed at the location. The collected computing task information can be parsed to get a predicted approximate power usage information for each task. Tasks can be scheduled based on the predicted approximate power usage information to improve (e.g., maximize) usage of power from an unstable power source.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a graph illustrating a power output from a wind farm;

FIG. 2 shows a graph of power usage mapped against task start and end times;

FIGS. 3A and B show power usage graphs from parsing collected information to get approximate power usage information for different tasks;

FIGS. 4A and 4B show power usage graphs where time slots are defined and tasks are assigned to one or more time slots;

FIG. 5 shows a power usage graph with tasks scheduled based on the power prediction result and task power usage information to make full use of the unstable power;

FIG. 6 shows a power usage graph showing how a task's CPU usage can be suppressed to reduce energy requirement if tasks cannot be finished on time;

FIG. 7 shows a flow chart illustrating a process consistent with an illustrative embodiment; and

FIG. 8 is a functional block diagram illustration of a computer hardware platform that can be used to implement the method for workload management, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide a computer-implemented method, a system for performing the computer-implemented method, and a computer program code having instructions for performing the computer implemented method. The computer implemented method can include collecting power usage information from a location and collecting computing task information with respect to computing tasks performed at the location. The collected computing task information can be parsed to get a predicted approximate power usage information for each task. Tasks can be scheduled based on the predicted approximate power usage information to improve (e.g., maximize) usage of power from an unstable power source. Such methods can optimize the use of unstable power for a computing location, such as a data center.

In embodiments, which can be combined with the preceding embodiment, the method can further include suppressing a central processing unit's usage for a particular task if the particular task cannot be finished within a scheduled time for the particular task. By suppressing the CPU usage for a task that cannot be finished, the later scheduled tasks can proceed as scheduled.

In embodiments, which can be combined with any of the preceding embodiments, the computing task information includes a start time and an end time for the computing tasks. Such information can be used to determine how many slots each task may occupy, as described in greater detail below.

In embodiments, which can be combined with any of the preceding embodiments, the method can include receiving a new task to be performed at the location. The method can then repeat, including the collection of updated power usage information from the location, wherein the power usage information includes power usage for the new task and the collection of updated computing task information with respect to the new task. The updated collected computing task information can be parsed to get the predicted approximate power usage information for each task, including the new task and the tasks can be scheduled based on the predicted approximate power usage information to improve (e.g., maximize) usage of power from the unstable power source.

In embodiments, which can be combined with any of the preceding embodiments, the method can include defining a time slot for all tasks, tasks can be divided into some parts by this time slot. This time slot is typically a consistent time period, such as one minute, for example. A linear equation can be generated for each time slot. Each linear equation can provide a sum of power used by each task during a given time slot. A plurality of different combinations of the linear equations can be created and each combination of linear equations can be solved to determine an assumed task power usage for each task.

In embodiments, which can be combined with any of the preceding embodiments, the method can further include computing a variance between the assumed task power usage and real power usage for each solution for each combination of linear equations. The solution providing a lowest value of the variance can be used as providing the assumed task power usage.

In embodiments, which can be combined with any of the preceding embodiments, the method can further include measuring an incoming power from the unstable power source and scheduling the tasks based on a knapsack problem algorithm, where the measured incoming power is a knapsack and the scheduled tasks are items to fill the knapsack.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may provide a process model for workload management. This may have the technical effect of fully utilizing sustainable unstable power sources to provide for sustainable computing with a reduced environmental impact.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

There are usually some tasks for daily work, where the power usage and duration for the same task is same, and wind/optical power prediction can be at an hours level, one potential solution is to run more of these tasks based on the prediction. The problem is that there is no easy way to get the power usage of these tasks, and while one can get the power usage of a task by hardware, it is very expensive in terms of hardware requirements as well as time requirements for user intervention.

To resolve this issue, aspects of the present disclosure provide a solution to get power usage of tasks and schedule these tasks to make full use of the unstable power. Such a solution can (1) collect data center power usage information and tasks' information; (2) parse the collected information, determine proximate power usage information for different tasks, by (a) defining a time slot (e.g., a constant time slot, such as 1 minute) for all tasks, tasks can be divided into some parts by this time slot, (b) based on the data center power usage information and task information, and results from (a), equations can be generated, (c) combinations of these equations can be made while computing values that meet the equations, and (d) computing the solution of the equations based on variance of the assumed power usage and real power usage; (3) schedule tasks based on the power prediction result and task power usage information, making full use of the unstable power; (4) repeat above steps to handle the new coming tasks and existing tasks; and (5) suppress a task's CPU usage to reduce energy requirement if tasks cannot be finished on time. Details of this solution are provided in greater detail below.

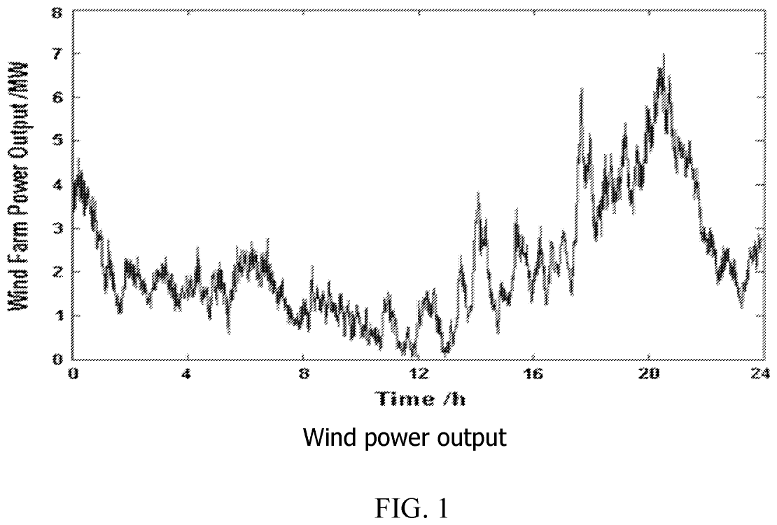

Referring to FIG. 1, a graph is shown of a typical wind power farm's power output. While the wind farm can provide sustainable power, such power source is considered to be “unstable,” meaning that the power output may be variable, such as, with wind power, the wind speed and time can vary the amount of power output.

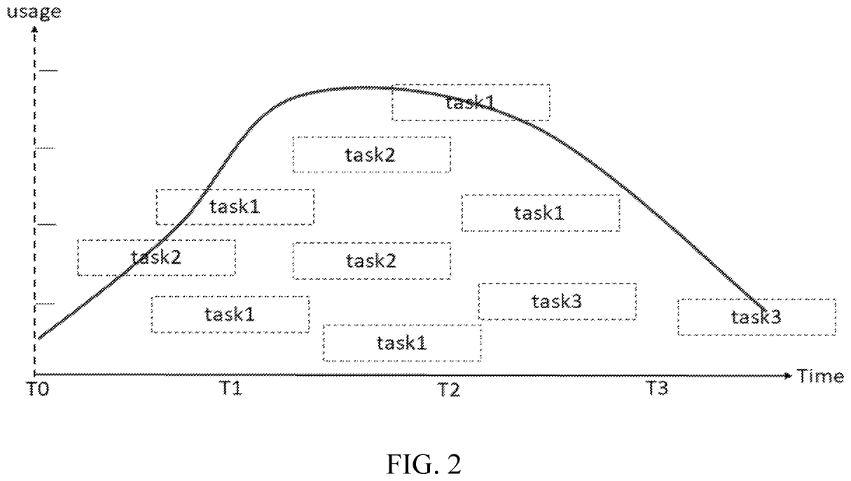

Referring to FIG. 2, information regarding power usage of a data center (or other similar computing center) can be obtained. Aspects of the present disclosure can create a power usage timeline and the corresponding tasks' start and end time. Such information may be obtained, for example, by a log file, by checking the process information, or the like. At this stage, the power usage of every task is not known. Thus, as can be seen in FIG. 2, the size of each tasks' box is the same for each time period.

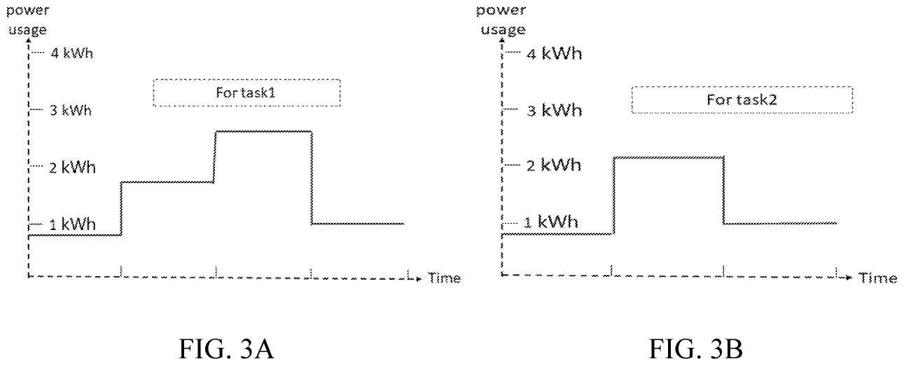

Referring to FIGS. 3A and 3B, the collected information can be parsed to get approximate power usage information for different tasks. Aspects of the present disclosure can try to determine the task level power usage as illustrated in detail below. The result is approximate, as it is impacted by many factors, e.g., power can be consumed by a non-task component, power usage is not stable during a period, or the like.

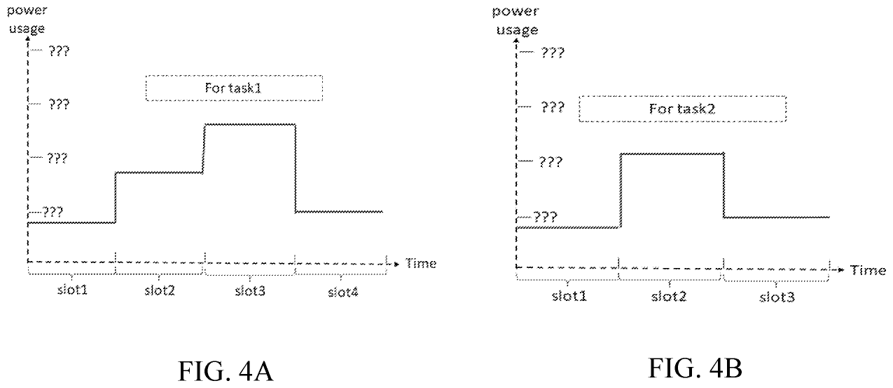

Referring to FIGS. 4A and 4B, a time slot (e.g., 1 minute) can be defined for all tasks and the tasks can be divided into some parts by these time slots. As indicated in the graphs, as this stage, the power requirements are unknown at this stage.

Based on the data center power usage information and task information, as well as results from the defining time slots and assigning tasks to time slots, information such as the following can be obtained. During 9:00˜9:01, the data center power usage is M kWh, where 1 task1 with 1 time slot1 is called, 1 task1 with 0.5 time slot1 is called, and 0.5 time slot2 is called, where this task starts at 30 seconds before 9:00, and time slot is 60 seconds, 30 seconds of slot 1 and 30 seconds of slot 2 are at this period, this is why 0.5 (30/60) is used, 3 task2 with time slot1 called. During 9:01˜9:02, the data center power usage is N kWh, where 1 task1 with 1 time slot2 is called, 1 task1 with 0.5 time slot2 and 0.5 time slot3 is called, and 3 task2 with time slot2 is called.

The power usage for a taskA on slot B can be defined as X_tA_SB. The following linear equations can be obtained:

$$equation 1 ;$$

$$1 * X\_t1 \_s1 + 0.5 * X\_t1 \_s1 + 0.5 * X\_t1 \_s2 + 3 * X\_t2 \_s1 + … = M // for power usage during 9 : 00 ∼ 9 : 01 ,$$

$$equation 2 ;$$

$$1 * X\_t1 \_s2 + 0.5 * X\_t1 \_s2 + 0.5 * X\_t1 \_s3 + 3 * X\_t2 \_s2 + … = N // for power usage during 9 : 01 ∼ 9 : 02 ,$$

$$and$$

$$additional equations for power usage during x : xx ∼ y : yy , \qquad equation Z .$$

Power usage (M and N in the equations) is known, what is desired is to get is X_tA_sB (unknown variable) values in these linear equations.

Aspects of the present disclosure can compute combinations of these equations, where every combination includes all the X_tA_sB, for the combination that only has one solution for the equations in it. This can be obtained by some known solutions, such as the elimination method, and the equations can be added into a candidate list. The solution here is the values of X_tA_sB that meet the equations.

In some embodiments, combination for equations 1/2/3/4, can include equations 1/2/3 as one combination, equations 1/2/4 as another combination. For one combination, all X_tA_sB should be included. This is to ensure the solution obtained can apply to all equations.

If a solution for any combination cannot be obtained (too many unknown variables), the count of X_tA_sB can be reduced by setting some nearby or all nearby X_tA_SB of a task to be the same value. Nearby X_tA_SB can be, for example, X_tA_s1 and X_tA_s2, which is for same task and with nearby time slot. Thus, there will be fewer unknown variables, and the solutions can be obtained. Rough results can be obtained in this way, which can be necessary when there are not enough historical data.

For every combination in the candidate, the solution of the equations in it can be obtained and the solution can be applied to the left equations that are not in this combination to get the assumed power usage. The variance of the assumed power usage and real power usage can be obtained and the solution from the combination with smallest variance can used as the task power usage.
1*X_t1_s1+0.5*X_t1_s1+0.5*X_t1_s2+3*X_t2_s1+ . . . =m, where the value of X_tA_sB is known and m is the assumed power usage.
1*X_t1_s1+0.5*X_t1_s1+0.5*X_t1_s2+3*X_t2_s1+ . . . =M, where M is the history power usage, where the variance=Σ(M−m)²/n, where n is the number of equations for this variance.

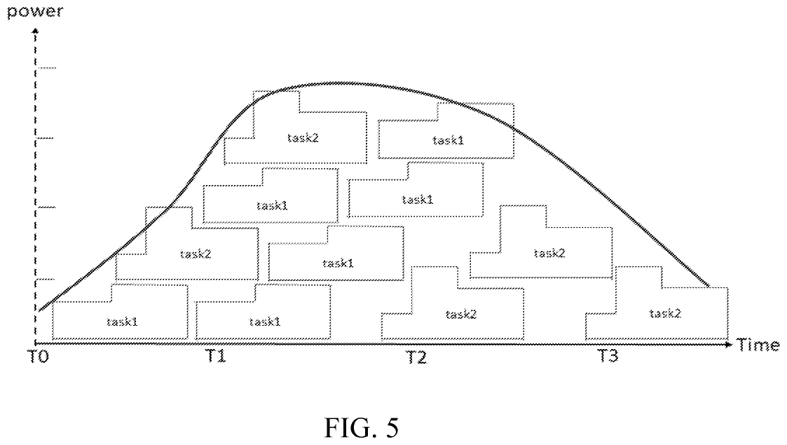

Referring to FIG. 5, tasks can be scheduled based on the power prediction result and task power usage information, making full use of the unstable power. As the quantity of incoming power can be obtained and the power consumed for every task is calculated as described above, task scheduling can be performed, for example, as a solution to the knapsack problem. The coming renewable power is the knapsack, the tasks with different power usage are the items that need to be filled into the knapsack, thus providing the task scheduling as a knapsack problem solution algorithm.

The above steps can be repeated to handle the new coming tasks and existing tasks. For the new coming tasks with unknown power usage, they can be scheduled first, and then the power usage can be obtained with above steps to then schedule them together with existing tasks. The power usage of existing tasks may change. To handle this case, aspects of the present disclosure can repeat the above steps to get the new power usage so that the renewable power still can be fully used. The new and updated tasks can be handled dynamically through the methods of the present disclosure. The accurate task power usage can be obtained after repeated calculations, and, accordingly, the schedule policy can be accurate.

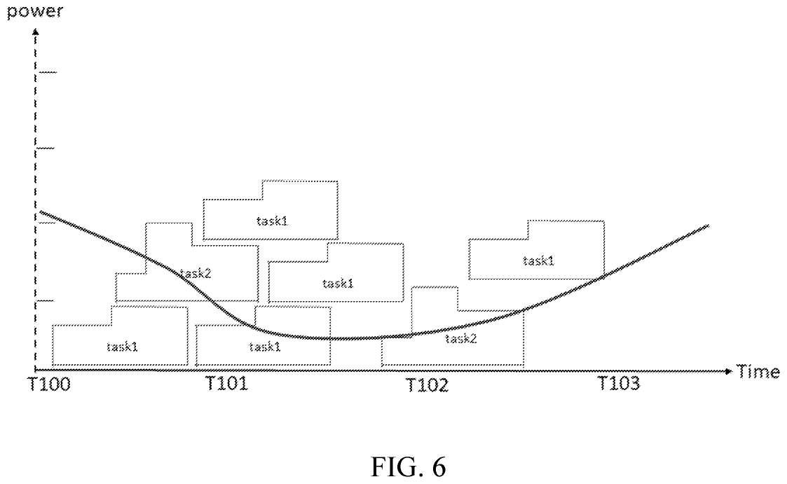

Referring to FIG. 6, a task's CPU usage can be suppressed to reduce energy requirement if tasks cannot be finished on time. For exceptions that tasks cannot be finished on time and there is not enough energy, the task's CPU usage can be reduced by cgroup, for example, or other conventional manners, to ensure these tasks still can run with the current energy.

### Example Process

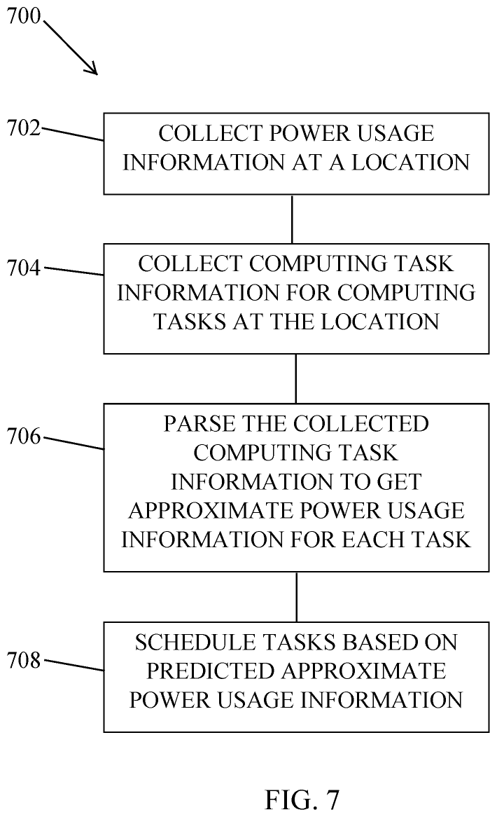

It may be helpful now to consider a high-level discussion of an example process. To that end, FIG. 7 presents an illustrative process 700 related to the method for workload management. Process 700 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 7, block 702 of process 700, can include an act of collecting power usage information from a location, such as a computing data center. Block 704 can include an act of collecting computing task information with respect to computing tasks performed at the location. This task information can include, for example, a start time and an end time for each of the tasks. Block 706 can include parsing the collected computing task information to get a predicted approximate power usage information for each task. Finally, block 708 can include scheduling tasks based on the predicted approximate power usage information to improve (e.g., maximize) usage of power from an unstable power source.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

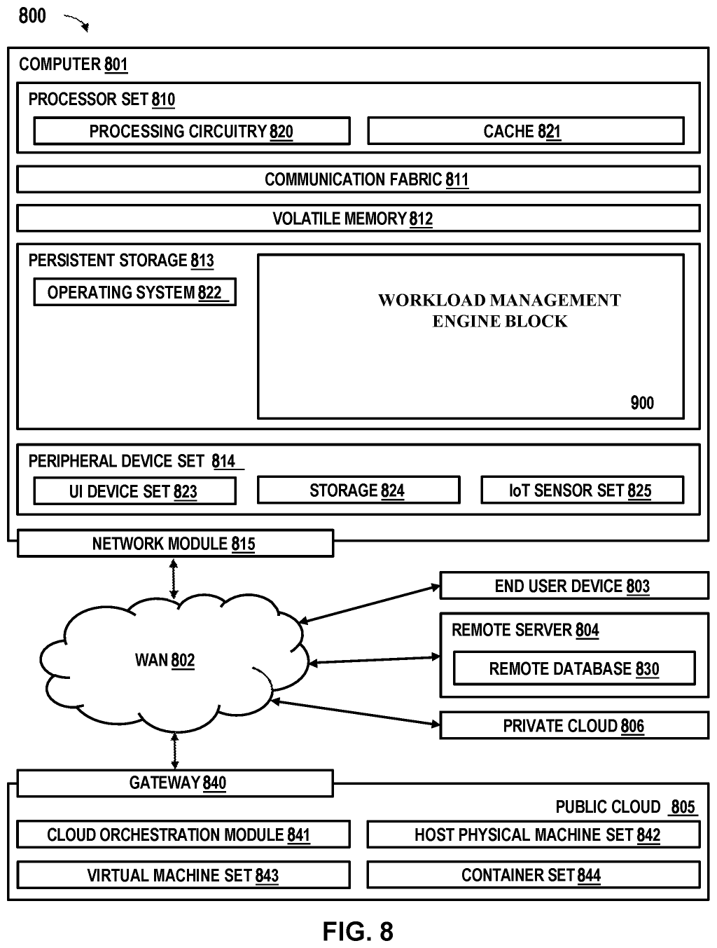

Referring to FIG. 8, computing environment 800 includes an example of an environment for the execution of at least some of the computer code involved in performing the inventive methods, including a workload management engine block 900. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for workload management, comprising:
collecting power usage information from a location;
collecting computing task information with respect to computing tasks performed at the location;
parsing the collected computing task information to determine a predicted approximate power usage information for each computing task; and
scheduling the computing tasks based on the predicted approximate power usage information to improve a usage of power from an unstable power source.

2. The computer-implemented method of claim 1, further comprising suppressing a central processing unit's usage for a particular computing task if the particular computing task cannot be finished within a scheduled time for the particular computing task.

3. The computer-implemented method of claim 1, wherein the collected computing task information includes a start time and an end time for the computing tasks.

4. The computer-implemented method of claim 1, further comprising:
receiving a new computing task to be performed at the location;
collecting updated power usage information from the location, wherein the power usage information includes power usage for the new computing task;
collecting updated computing task information with respect to the new computing task;
parsing the updated collected computing task information to determine the predicted approximate power usage information for each computing task, including the new computing task; and
scheduling the computing tasks based on the predicted approximate power usage information to improve the usage of power from the unstable power source.

5. The computer-implemented method of claim 1, further comprising:
defining a time slot for each of the computing tasks, wherein the computing tasks are divided into some parts by their corresponding time slot;
generating a linear equation for each time slot, each linear equation providing a sum of power used by each computing task during the time slot;
creating a plurality of different combinations of the linear equations; and
solving each combination of linear equations to determine an assumed task power usage for each computing task.

6. The computer-implemented method of claim 5, further comprising:
computing a variance between the assumed task power usage and a real power usage for each solution for each combination of linear equations; and
using the solution providing a lowest value of the variance as providing the assumed task power usage.

7. The computer-implemented method of claim 5, wherein the time slot is a constant time slot.

8. The computer-implemented method of claim 1, further comprising:
measuring an incoming power from the unstable power source; and
scheduling the computing tasks based on a knapsack problem algorithm, wherein the measured incoming power is a knapsack and the scheduled tasks are items to fill the knapsack.

9. A system comprising:
a processor;
a data bus coupled to the processor;
a memory coupled to the data bus; and
a computer-usable medium embodying a computer program code, the computer program code comprising instructions executable by the processor and configured to:
collect power usage information from a location;
collect computing task information with respect to computing tasks performed at the location;
parse the collected computing task information to determine a predicted approximate power usage information for each computing task; and
schedule the computing tasks based on the predicted approximate power usage information to improve a usage of power from an unstable power source.

10. The system of claim 9, wherein the instructions are further configured to suppress a central processing unit's usage for a particular computing task if the particular computing task cannot be finished within a scheduled time for the particular computing task.

11. The system of claim 9, wherein the collected computing task information includes a start time and an end time for the computing tasks.

12. The system of claim 9, wherein the instructions are further configured to:
receive a new computing task to be performed at the location;
collect updated power usage information from the location, wherein the power usage information includes a power usage for the new computing task;
collect updated computing task information with respect to the new computing task;
parse the updated collected computing task information to determine the predicted approximate power usage information for each computing task, including the new computing task; and
schedule the computing tasks based on the predicted approximate power usage information to improve the usage of power from the unstable power source.

13. The system of claim 9, wherein the instructions are further configured to:
define a time slot for each of the computing tasks, wherein the computing tasks are divided into some parts by their corresponding time slot;
generate a linear equation for each time slot, each linear equation providing a sum of power used by each computing task during the time slot;
create a plurality of different combinations of the linear equations; and
solve each combination of linear equations to determine an assumed task power usage for each computing task.

14. The system of claim 13, wherein the instructions are further configured to:
compute a variance between the assumed task power usage and a real power usage for each solution for each combination of linear equations; and
use the solution providing a lowest value of the variance as providing the assumed task power usage.

15. The system of claim 9, wherein the instructions are further configured to:
measure an incoming power from the unstable power source; and
schedule the computing tasks based on a knapsack problem algorithm, where the measured incoming power is a knapsack and the scheduled computing tasks are items to fill the knapsack.

16. A computer program product for computing workload management, the computer program product comprising a computer readable storage medium having program instructions embodied therewith, the program instructions executable by a computer to cause the computer to:
collect power usage information from a location;
collect computing task information with respect to computing tasks performed at the location;
parse the collected computing task information to determine a predicted approximate power usage information for each computing task; and
schedule computing tasks based on the predicted approximate power usage information to improve a usage of power from an unstable power source.

17. The computer program product of claim 16, wherein the instructions are further configured to suppress a central processing unit's usage for a particular computing task if the particular computing task cannot be finished within a scheduled time for the particular computing task.

18. The computer program product of claim 16, wherein the collected computing task information includes a start time and an end time for the computing tasks.

19. The computer program product of claim 16, wherein the instructions are further configured to:
receive a new computing task to be performed at the location;
collect updated power usage information from the location, wherein the power usage information includes a new computing task power usage for the new computing task;
collect updated computing task information with respect to the new computing task;
parse the updated collected computing task information to get the predicted approximate power usage information for each computing task, including the new computing task; and
schedule the computing tasks based on the predicted approximate power usage information to improve a usage of power from the unstable power source.

20. The computer program product of claim 16, wherein the instructions are further configured to:
define a time slot for each of the computing tasks, wherein the computing tasks are divided into some parts by their corresponding time slot;
generate a linear equation for each time slot, each linear equation providing a sum of power used by each computing task during the time slot;
create a plurality of different combinations of the linear equations;
solve each combination of linear equations to determine an assumed task power usage for each computing task;
compute a variance between the assumed task power usage and a real power usage for each solution for each combination of linear equations; and
use the solution providing a lowest value of the variance as providing the assumed task power usage.
